(19) United States
(12) Patent Application Publication
(10) Pub. No.: US 2013/0186493 A1
(43) Pub. Date: Jul. 25, 2013

(54) BI-DIRECTIONAL FLUID FLOW REGULATOR WITH FUNNEL SHAPED BAFFLES

(71) Applicants: Jim A. Clark, Jupiter, FL (US); Charles W. Whipple, IV, Okeechobee, FL (US)

(72) Inventors: Jim A. Clark, Jupiter, FL (US); Charles W. Whipple, IV, Okeechobee, FL (US)

(73) Assignee: UNITED TECHNOLOGIES CORPORATION, Hartford, CT (US)

(21) Appl. No.: 13/357,294

(22) Filed: Jan. 24, 2012

(51) Int. Cl. F16K 11/00; F16K 31/02; F16K 1/00; F16L 55/00

(52) U.S. Cl. 137/625; 138/40; 251/129.15; 251/324

(57) ABSTRACT

An apparatus for bi-directionally regulating flow of an actuation fluid includes a conduit and a plurality of baffles. The conduit includes a conduit flow channel that extends longitudinally along a centerline between a first conduit end and a second conduit end. The baffles are sequentially non-coaxially arranged in the conduit. Each of the baffles includes a baffle flow channel that laterally tapers and extends, in a longitudinal direction towards the second conduit end, from a first baffle end to a baffle orifice at a second baffle end. The first baffle end is connected to the conduit, and extends laterally across the conduit flow channel.

This invention was made with government support under Contract No. 4500014103 awarded by the United States Air Force. The government may have certain rights in the invention.

### BACKGROUND OF THE INVENTION

1. Technical Field

The present invention relates generally to a fluid actuated system and, in particular, to a fluid actuated system with a bi-directional fluid flow regulator.

2. Background Information

A propellant delivery system for a gas turbine and/or rocket engine may include a valve that controls propellant flow to one or more propellant injectors arranged, for example, in an engine combustion section or an engine augmentor section. Such a valve may be actuated by an actuation fluid. The actuation fluid, for example, may be directed into and out of a valve piston chamber to respectively open and close the valve. The opening and closing of the valve may correspondingly increase and decrease propellant flow to the injectors.

An orifice may be connected to the valve to control the actuation fluid flow rate into and out of the valve piston chamber. In some applications, for example, it may be desirable to reduce the actuation fluid flow rate into the valve piston chamber with the orifice to reduce the opening speed and the concomitant possibility of damage to the valve components. The orifice, however, may also reduce the actuation fluid flow rate out of the valve piston chamber. Reducing the actuation fluid flow rate out of the valve piston chamber may correspondingly increase propellant flow cutoff times to the propellant injectors, which may be disadvantageous during engine shutdown and emergency procedures.

There is a need in the art for a flow regulator that may provide actuation fluid to an actuator at a first flow rate, and receive the actuation fluid from the actuator at a second flow rate that is different than the first flow rate.

### SUMMARY OF THE DISCLOSURE

According to a first aspect of the invention, an apparatus is provided for bi-directionally regulating flow of an actuation fluid. The apparatus includes a conduit that extends longitudinally along a centerline between a first conduit end and a second conduit end, and a plurality of baffles that are sequentially non-coaxially arranged in the conduit. Each of the baffles includes a baffle flow channel that laterally tapers and extends, in a longitudinal direction towards the second conduit end, from a first baffle end to a baffle orifice at a second baffle end. The first baffle end is connected to the conduit, and extends laterally across the conduit flow channel

According to a second aspect of the invention, a valve assembly is provided that includes an actuation fluid actuated valve connected between an inlet and an outlet, and an actuation fluid flow regulator. The flow regulator includes a conduit flow channel that extends longitudinally along a centerline, and a plurality of funnel shaped baffles that are sequentially non-coaxially arranged in the conduit flow channel The actuation fluid flows through the baffles to the valve at a first flow rate, and through the baffles away from the valve at a second flow rate that is different than the first flow rate.

The foregoing features and the operation of the invention will become more apparent in light of the following description and the accompanying drawings.

### BRIEF DESCRIPTION OF THE DRAWINGS

FIG. 1 is a block diagram illustration of a valve assembly that includes an actuation fluid actuated valve and a bi-directional actuation fluid flow regulator;

FIG. 2 is a cross-sectional illustration of a bi-directional actuation fluid flow regulator;

FIG. 3 is a side-sectional illustration of the flow regulator illustrated in FIG. 2;

FIG. 4 is a cross-sectional illustration of another bi-directional actuation fluid flow regulator;

FIG. 5 is a side-sectional illustration of the flow regulator illustrated in FIG. 4;

FIG. 6 is a cross-sectional illustration of another bi-directional actuation fluid flow regulator; and

FIG. 7 is a side-sectional illustration of the flow regulator illustrated in FIG. 6.

### DETAILED DESCRIPTION OF THE INVENTION

FIG. 1 illustrates a valve assembly 10 that may be included, for example, in a propellant delivery system for a gas turbine and/or rocket engine. The valve assembly 10 may include an actuation fluid inlet/outlet 12, a fluid inlet 14 (e.g., a propellant inlet), a fluid outlet 16 (e.g., a propellant outlet), an actuation fluid actuated valve 18, and a bi-directional actuation fluid flow regulator 20.

The valve 18 may be configured as, for example, a two-way piston spring valve as illustrated in FIG. 1. In another example, the valve may be configured as a three-way piston solenoid valve. The present invention, however, is not intended to be limited to any particular valve configuration.

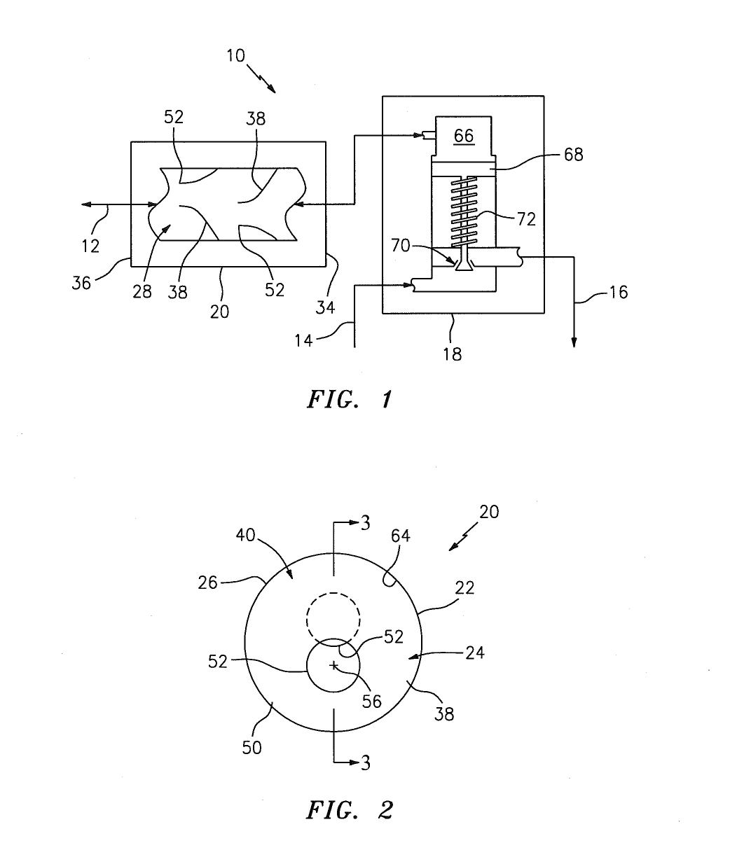

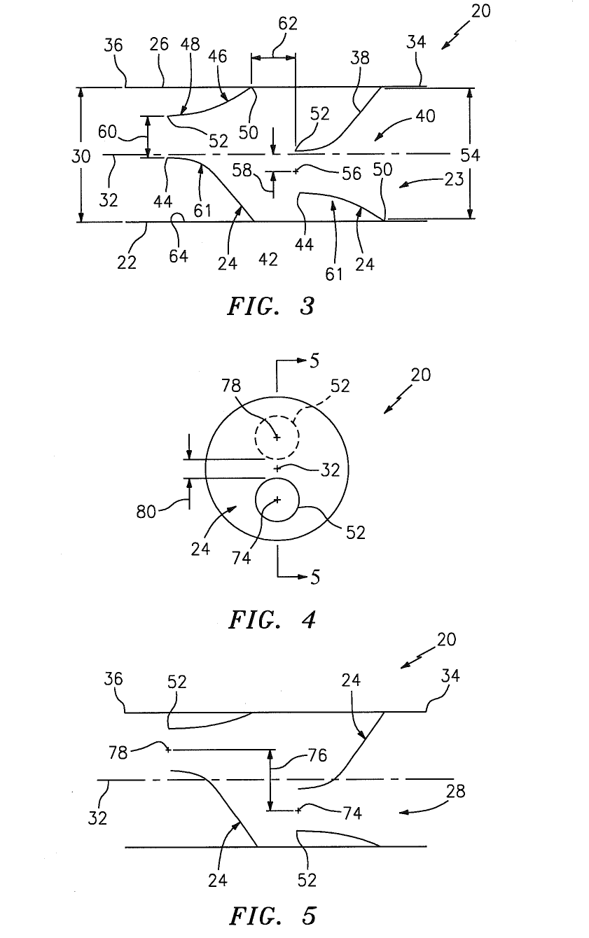

Referring to FIGS. 2 and 3, the flow regulator 20 includes a conduit 22 and a plurality of funnel shaped baffles 24 (e.g., plunged orifice flow restrictions). The conduit 22 may have a (e.g., cylindrical) tubular conduit sidewall 26 that forms a conduit flow channel 28 with a conduit diameter 30. The conduit flow channel 28 may extend along a longitudinal (e.g., axial) centerline 32 through the conduit 22 between a first conduit end 34 and a second conduit end 36.

One or more of the baffles 24 may each include a (e.g., circular tubular) baffle wall 38 that forms a funnel shaped baffle flow channel 40. The baffle wall 38 may extend along the centerline 32 between a first baffle end 42 and a second baffle end 44. The baffle wall 38 may include a first baffle wall segment 46 longitudinally connected to a second baffle wall segment 48. The first baffle wall segment 46 may extend laterally inward (e.g., radially taper) along the centerline 32 from the first baffle end 42 to the second baffle wall segment 48. The second baffle wall segment 48 may extend laterally inward along the centerline 32 from the first baffle wall segment 46 to the second baffle end 44. A slope of taper of the first baffle wall segment 46 may be substantially greater than a slope of taper of the second baffle wall segment 48. The “slope of taper” may be defined as a change in baffle wall segment diameter versus baffle wall segment length along the centerline 32.

The baffle flow channel 40 may extend laterally inward along the centerline 32 from a (e.g., circular) first baffle orifice 50 to a (e.g., circular) second baffle orifice 52. The first baffle orifice 50 may be arranged concentrically with the conduit flow channel 28, and located at the first baffle end 42. The first baffle orifice 50 may have a first orifice diameter 54 that is substantially equal to (or less than) the conduit diameter 30. The second baffle orifice 52 may be arranged non-concentrically (or concentrically) with the first baffle orifice 50, and located at the second baffle end 44. A centroid 56 of the second baffle orifice 52, for example, may be located a first lateral (e.g., radial) distance 58 from the centerline 32. The second baffle orifice 52 may have a second orifice diameter 60 that is less than the first orifice diameter 54. The baffle flow channel 40 may include a baffle neck 61 arranged, for example, where the first baffle wall segment 46 is connected to the second baffle wall segment 48.

The baffles 24 may be discretely arranged in the conduit flow channel 28 sequentially (e.g., serially) along the centerline 32 between the first conduit end 34 and the second conduit end 36. The second baffle end 44 of one of the baffles 24, for example, may be spatially separated from the first baffle end 42 of an adjacent one of the baffles 24 along the centerline 32 by a longitudinal distance 62. The first baffle ends 42 may be connected to an inner radial surface 64 of the conduit sidewall 26, and extend laterally across the conduit flow channel 28.

Referring to FIG. 1, the valve 18 is fluidly connected between the fluid inlet 14 and the fluid outlet 16. The flow regulator 20 is fluidly connected between the actuation fluid inlet/outlet 12 and the valve 18. The first conduit end 34, for example, may be connected to the valve 18. The second conduit end 36 may be connected to the actuation fluid inlet/outlet 12.

During a first mode of operation, an actuation fluid (e.g., hydraulic fluid, liquid propellant, helium, nitrogen, air, etc.) may be directed through the flow regulator 20 in a first direction in order to open the valve 18. The actuation fluid, for example, may be directed from the actuation fluid inlet/outlet 12 into the conduit flow channel 28. The actuation fluid may relatively slowly and turbulently flow through second baffle orifices 52 towards the first conduit end 34 at a first flow rate. The actuation fluid subsequently is directed from the conduit flow channel 28 into a piston chamber 66 in the valve 18. The increasing quantity of actuation fluid directed into the piston chamber 66 may axially move a valve piston 68 and thereby open a valve aperture 70. The opening of the valve aperture 70 permits a fluid (e.g., liquid propellant) to flow from the fluid inlet 14 to the fluid outlet 16 through the valve 18.

During a second mode of operation, the actuation fluid may be directed through the flow regulator 20 in a second direction in order to close the valve 18. The actuation fluid, for example, may be directed from the piston chamber 66 into the conduit flow channel 28. The actuation fluid may be relatively quickly funneled by the baffle walls 38 through the second baffle orifices 52 towards the second conduit end 36 at a second flow rate. The second flow rate may be substantially (e.g., about forty percent) greater than the first flow rate since the funnel shape of the baffles 24 reduces fluid drag through the conduit flow channel 28 in this second direction as compared to the first direction. The actuation fluid subsequently is directed from the conduit flow channel 28 into the actuation fluid inlet/outlet 12. A valve spring 72 may axially move the valve piston 68 as the quantity of actuation fluid within the piston chamber 66 decreases and thereby close the valve aperture 70. The closing of the valve aperture 70 may decrease or substantially stop the flow of the fluid from the fluid inlet 14 to the fluid outlet 16.

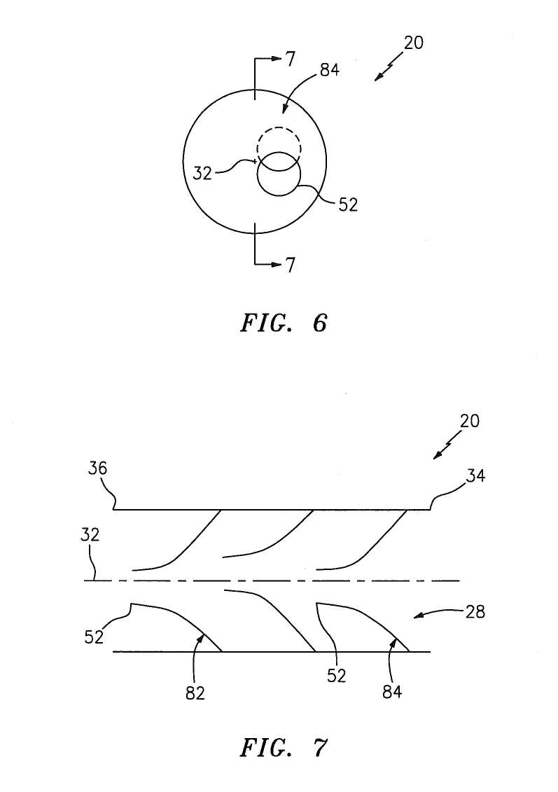

In some embodiments, for example as illustrated in FIGS. 4 and 5, the second baffle orifices 52 of the baffles 24 may be laterally arranged on opposite sides of the centerline 32; e.g., laterally offset from one another. A centroid 74 of one of the second baffle orifices 52, for example, may be located a second lateral distance 76 from a centroid 78 of another one of the second baffle orifices 52. The baffles 24 may also be arranged such that the second baffle orifices 52 are separated by a third lateral distance 80. In other embodiments, for example as illustrated in FIGS. 6 and 7, the second baffle orifices 52 of at least some of the baffles (e.g., 82 and 84) may be concentrically aligned and/or laterally arranged towards one side of the centerline 32.

In some embodiments, the second baffle orifices 52 of at least some of the (e.g., adjacent) baffles may have substantially equal second orifice diameters 60. In other embodiments, the second baffle orifices of at least some of the (e.g., adjacent) baffles may have different second orifice diameters. In still other embodiments, the baffle necks 61 of at least some of the (e.g., adjacent) baffles may have substantially equal and/or different baffle neck diameters.

In an alternate embodiment, the first conduit end 34 may be connected to the actuation fluid inlet/outlet 12, and the second conduit end 36 may be connected to the valve 18.

While various embodiments of the present invention have been disclosed, it will be apparent to those of ordinary skill in the art that many more embodiments and implementations are possible within the scope of the invention. The flow regulator, for example, may be configured with various types of fluid actuated apparatuses and systems other than fluid actuated valves. The flow regulator may also be utilized in various applications other than those for gas turbine and/or rocket engine propellant delivery systems. Accordingly, the present invention is not to be restricted except in light of the attached claims and their equivalents.

What is claimed is:

1. An apparatus for bi-directionally regulating flow of an actuation fluid, comprising:
a conduit comprising a conduit flow channel that extends longitudinally along a centerline between a first conduit end and a second conduit end; and
a plurality of baffles sequentially non-coaxially arranged in the conduit, each of the plurality of baffles comprising a baffle flow channel that laterally tapers and extends, in a longitudinal direction towards the second conduit end, from a first baffle end to a baffle orifice at a second baffle end, wherein the first baffle end is connected to the conduit and extends laterally across the conduit flow channel.

2. The apparatus of claim 1, wherein the actuation fluid flows through the baffle orifices from the first conduit end to the second conduit end at a first flow rate, and from the second conduit end to the first conduit end at a second flow rate that is greater than the first flow rate.

3. The apparatus of claim 1, wherein a centroid of the baffle orifice in a first of the plurality of baffles and a centroid of the baffle orifice in a second of the plurality of baffles are separated by a lateral distance.

4. The apparatus of claim 3, wherein the baffle orifice in the first of the plurality of baffles and the baffle orifice in the second of the plurality of baffles are separated by a second lateral distance.

5. The apparatus of claim 1, wherein the baffle orifice in a first of the plurality of baffles and the baffle orifice in a second of the plurality of baffles are concentrically aligned.

6. The apparatus of claim 1, wherein a centroid of the baffle orifice in a first of the plurality of baffles and a centroid of the baffle orifice in a second of the plurality of baffles are located on opposite sides of the centerline.

7. The apparatus of claim 1, wherein a centroid of the baffle orifice in a first of the plurality of baffles and a centroid of the baffle orifice in a second of the plurality of baffles are located to a side of the centerline.

8. The apparatus of claim 1, wherein a first of the plurality of baffles and an adjacent second of the plurality of baffles are separated by a longitudinal distance.

9. The apparatus of claim 1, wherein a diameter of the baffle orifice in a first of the plurality of baffles is substantially equal to a diameter of the baffle orifice in a second of the plurality of baffles.

10. The apparatus of claim 1, wherein a first of the plurality of baffles further comprises a first baffle wall segment that laterally tapers and longitudinally extends from the respective first baffle end to a second baffle wall segment that longitudinally extends along the centerline to the respective baffle orifice.

11. The apparatus of claim 10, wherein the second baffle wall segment laterally tapers from the first baffle wall segment to the baffle orifice, and a slope of taper of the first baffle wall segment is different than a slope of taper of the second baffle wall segment.

12. A valve assembly, comprising:
an inlet;
an outlet;
a valve connected between the inlet and the outlet, and actuated by an actuation fluid; and
an actuation fluid flow regulator comprising a conduit flow channel that extends longitudinally along a centerline, and a plurality of funnel shaped baffles sequentially non-coaxially arranged in the conduit flow channel, wherein the actuation fluid flows through the plurality of funnel shaped baffles to the valve at a first flow rate, and the actuation fluid flows through the plurality of funnel shaped baffles away from the valve at a second flow rate that is different than the first flow rate.

13. The valve assembly of claim 12, wherein each of the plurality of baffles comprises a baffle flow channel that laterally tapers and longitudinally extends from a first baffle end to a baffle orifice at a second baffle end, and wherein the first baffle end extends laterally across the conduit flow channel.

14. The valve assembly of claim 13, wherein a centroid of the baffle orifice in a first of the plurality of baffles and a centroid of the baffle orifice in a second of the plurality of baffles are separated by a lateral distance.

15. The valve assembly of claim 14, wherein the baffle orifice in the first of the plurality of baffles and the baffle orifice in the second of the plurality of baffles are separated by a second lateral distance.

16. The valve assembly of claim 13, wherein the baffle orifice in a first of the plurality of baffles and the baffle orifice in a second of the plurality of baffles are concentrically aligned.

17. The valve assembly of claim 13, wherein a centroid of the baffle orifice in a first of the plurality of baffles and a centroid of the baffle orifice in a second of the plurality of baffles are located on opposite sides of the centerline.

18. The valve assembly of claim 13, wherein a first of the plurality of baffles and an adjacent second of the plurality of baffles are separated by a longitudinal distance.

19. The valve assembly of claim 13, wherein a diameter of the baffle orifice in a first of the plurality of baffles is substantially equal to a diameter of the baffle orifice in a second of the plurality of baffles.

20. The valve assembly of claim 12, wherein the valve comprises at least one of a piston valve, a solenoid valve, a two-way valve and a three-way valve.
